(19) United States
(12) Patent Application Publication
(10) Pub. No.: US 2022/0152546 A1
(43) Pub. Date: May 19, 2022

(54) ACTIVATED CARBON MODIFICATION METHOD, FILTER MESH STRUCTURE AND USE THEREOF, AND FILTER MATERIAL REGENERATION METHOD

(71) Applicant: GREENFILTEC LTD., Taoyuan City (TW)

(72) Inventor: Yi-Hui YU, Taoyuan City (TW)

(73) Assignee: GREENFILTEC LTD., Taoyuan City (TW)

(21) Appl. No.: 17/528,513

(22) Filed: Nov. 17, 2021

(30) Foreign Application Priority Data
Nov. 19, 2020 (TW) 109140619

(51) Int. Cl. B01D 53/04; C01B 32/36; C01B 32/354; B01J 20/20; B01J 20/30; B01J 20/28; B01J 20/34

(52) U.S. Cl. CPC B01D 53/04; C01B 32/36; C01B 32/354; B01J 20/20; B01J 20/3085; B01D 2259/40083; B01J 20/2805; B01J 20/3475; B01J 20/3416; B01D 2257/708; B01D 2253/102; B01J 20/3071

(57) ABSTRACT

The present invention provides an activated carbon modification method, a filter mesh structure, use of the filter mesh structure, and a filter material regeneration method. The activated carbon modification method includes: providing an activated carbon; treating the surface of the activated carbon with hydrogen peroxide, so that the activated carbon forms a modified activated carbon; and removing the hydrogen peroxide from the surface of the modified activated carbon. The filter mesh structure includes the modified activated carbon, and the filter material therein can withstand hydrogen peroxide and temperatures above 100° C. and below 120° C. The filter material regeneration method includes: providing a filter material of the filter mesh structure as described above; treating the filter material with hydrogen peroxide; and removing substances from the surface of the modified activated carbon.

### TECHNICAL FIELD

The present invention relates to an activated carbon modification method, a filter mesh structure, use of the filter mesh structure, and a filter material regeneration method. Specifically, the present invention relates to an activated carbon modification method for removing airborne molecular contaminants (AMCs) containing volatile organic compounds (VOCs) in related processes of the semiconductor industry, a filter mesh structure, use of the filter mesh structure, and a filter material regeneration method.

### BACKGROUND

In the field of industrial manufacturing, such as the semiconductor manufacturing industry, in order to further improve the product yield, clean rooms are widely used to produce and manufacture products in a clean and pollution-free isolated environment.

In order to meet the environmental requirements of the clean room, fans and filter equipment are generally disposed at an air inlet of the clean room, so that airflow is driven by the fan to pass through a filter of the filter equipment and then enters the clean room to filter dust and various organic and inorganic contaminants.

One of the common methods for removing VOCs, such as benzene, acetone, isopropanol, ethyl acetate, dimethyl sulfoxide, ethanolamine, propylene glycol methyl ether, and propylene glycol methyl ether acetate, contained in AMCs is to use activated carbon materials for adsorption. The activated carbon materials have a good physical adsorption effect on alkane, olefin, ether, and benzene compounds from the VOCs through the pores thereof. However, the physical adsorption effect on alcohol, ketone, acid, and ester compounds from the VOCs is poor if only through the pores thereof. According to another aspect, the common methods for regenerating used activated carbon materials include thermal desorption and chemical desorption. The thermal desorption utilizes high temperature to desorb fat-soluble VOCs, which has a very high material loss. The chemical desorption produces uncontrollable by-products to cause outgassing, which results in more pollution in the clean room. This is the problem in the prior art. In particular, the line width in the advanced semiconductor process is getting narrower, and the outgassing of corrosive chemical substances or oxidizing agents causes decrease in yield. Therefore, how to effectively remove low-concentration (250 μg/m³) VOCs, and how to improve the regeneration effect and reduce the material loss are problems to be resolved.

### SUMMARY

An objective of the present invention is to provide an activated carbon modification method, which can produce a modified activated carbon that has a good effect for removing low-concentration VOCs.

Another objective of the present invention is to provide a filter mesh structure, which has a good effect for removing low-concentration VOCs, and has a good regeneration effect and a low material loss.

Another objective of the present invention is to provide use of the filter mesh structure for removing a VOC contained in an AMC, which has a good effect for removing low-concentration VOCs, and has a good regeneration effect and a low material loss.

Another objective of the present invention is to provide a filter material regeneration method, which has a good regeneration effect and a low material loss.

In the present invention, the activated carbon modification method includes: (A1000) providing an activated carbon; (A2000) treating the surface of the activated carbon with hydrogen peroxide, so that the activated carbon forms a modified activated carbon; and (A3000) removing the hydrogen peroxide from the surface of the modified activated carbon.

In an embodiment of the present invention, the step A2000 includes soaking the activated carbon in the hydrogen peroxide.

In an embodiment of the present invention, the concentration of the hydrogen peroxide is 2-50 wt %.

In an embodiment of the present invention, the step A3000 includes: (A3100) washing the modified activated carbon with water; and (A3200) heating the modified activated carbon to a temperature above 100° C. and below 120° C.

In an embodiment of the present invention, the step A3100 includes soaking the modified activated carbon in the water.

In the present invention, the filter mesh structure includes a first mesh structure, a second mesh structure, and a filter material. The first mesh structure has a first side. The second mesh structure has a second side, where the second mesh structure is disposed at a side of the first mesh structure, so that the second side faces the first side. The filter material is provided between the first side and the second side, and includes the modified activated carbon prepared by the foregoing activated carbon modification method. The filter material can withstand hydrogen peroxide and temperatures above 100° C.

In an embodiment of the present invention, the filter mesh structure includes no adhesive.

In the present invention, the filter material regeneration method includes: (B1000) providing a filter material of the filter mesh structure as described above; (B2000) treating the filter material with hydrogen peroxide; and (B3000) removing substances from the surface of the modified activated carbon.

In an embodiment of the present invention, the step B2000 includes soaking the filter material in the hydrogen peroxide.

In an embodiment of the present invention, the concentration of the hydrogen peroxide is 2-50 wt %.

In an embodiment of the present invention, the step B3000 includes: (B3100) washing the filter material with water; and (B3200) heating the filter material to a temperature above 100° C. and below 120° C.

In an embodiment of the present invention, the step B3100 includes soaking the filter material in the water.

### BRIEF DESCRIPTION OF THE DRAWINGS

FIG. 1 is a schematic flowchart of an embodiment of an activated carbon modification method according to the present invention.

FIG. 2 is a result graph of a three-repeat test.

FIG. 3 is a schematic diagram of an embodiment of a filter mesh structure according to the present invention.

FIG. 4 is a schematic flowchart of an embodiment of a filter material regeneration method according to the present invention.

### DETAILED DESCRIPTION

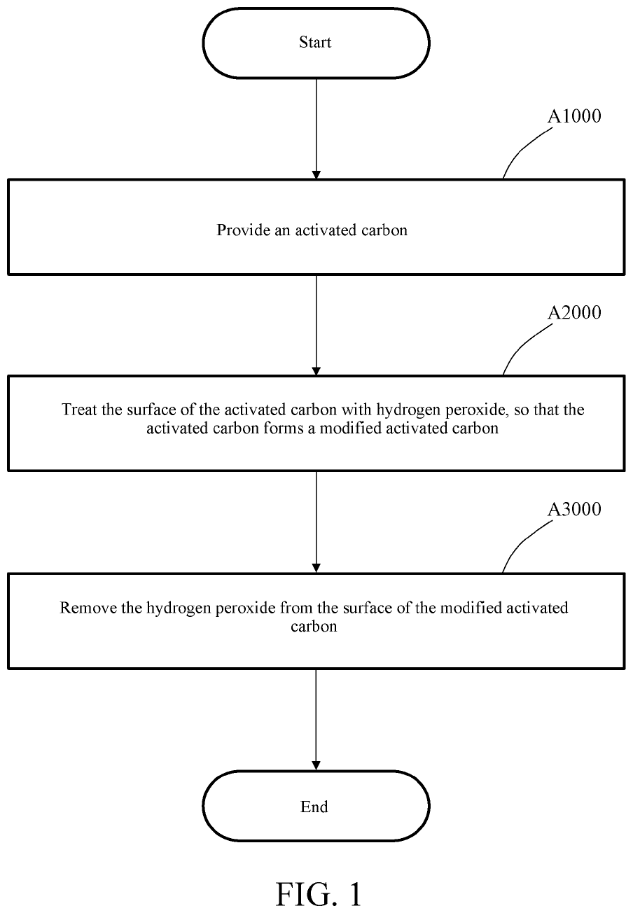

As shown in the schematic flowchart of the embodiment in FIG. 1, in the present invention, an activated carbon modification method includes the following steps.

Step A1000. Provide an activated carbon. Specifically, activated carbon particles with a particle size of 8-50 mesh are provided. However, in other different embodiments, a columnar, irregular block, or mesh activated carbon may be used.

Step A2000. Treat the surface of the activated carbon with hydrogen peroxide, so that the activated carbon forms a modified activated carbon. Further, oxygen-containing functional groups of the activated carbon are increased through the action of the hydrogen peroxide on the surface of the activated carbon. The surface of the activated carbon generally refers to the surface of the activated carbon in contact with the outside, including an outer side surface without holes and an inner side surface with holes. According to another aspect, compared with other oxidizing agents, hydrogen peroxide is easy to be removed and will not remain to cause further outgassing, which is economical and inexpensive, the waste liquid thereof is easy to handle, and process parameters such as concentration and reaction time are easy to control, thereby obtaining a stable process quality. Specifically, the step is soaking the activated carbon in the hydrogen peroxide. For the hydrogen peroxide, the concentration is preferably 2-50 wt %, and the pH value is 7±2. However, in other different embodiments, the surface of the activated carbon may be in contact with the hydrogen peroxide to react by repeated dipping or spraying. The concentration of the hydrogen peroxide may be adjusted according to factors such as temperature, way of contact with the surface of the activated carbon, and specifications of the activated carbon.

Step A3000. Remove the hydrogen peroxide from the surface of the modified activated carbon. Specifically, the modified activated carbon may be washed with water, and the modified activated carbon may be heated to a temperature above 100° C. and below 120° C. For example, the water used includes pure water and deionized water. The method of washing the modified activated carbon with water includes soaking the modified activated carbon in the water, repeated dipping, or spraying. The modified activated carbon is preferably heated to a temperature above 100° C. and below 120° C. However, in other different embodiments, the hydrogen peroxide may be removed from the surface of the modified activated carbon by standing, vacuum drying, or the like. From a different perspective, this step is to ensure that the hydrogen peroxide will not remain on the surface of the modified activated carbon after the surface of the activated carbon is treated to form the modified activated carbon. In an embodiment, the activated carbon modification method does not include pickling with, for example, hydrochloric acid, and includes ultrasonic vibration.

The modified activated carbon prepared by the activated carbon modification method of the present invention is detected as follows.

Specification/Preparation Method of Modified Activated Carbon

The modified activated carbon of the present invention is prepared by the foregoing activated carbon modification method. Specifically, 30 wt % of hydrogen peroxide and deionized water were used to prepare 1000 mL of hydrogen peroxide with concentrations of 4 wt %, 5 wt %, 15 wt %, 25 wt %, and 26 wt % respectively, and the prepared hydrogen peroxide and 300 g of activated carbon were mixed for 20 min and then dried at 100° C., so that the preparation of experimental groups 1A-1E was completed. Control group 1 was unmodified activated carbon, that is, 300 g of activated carbon was directly used.

Effect of Modified Activated Carbon for Removing Low-Concentration VOC

The modified activated carbon and the control group 1 were subjected to low-concentration VOC adsorption analysis. Isopropanol was selected as a to-be-tested VOC. The test conditions were isopropanol concentration of 250 μg/m³ and airflow of 65.2 The results are shown in Table 1 below.

TABLE 1

| | Hydrogen peroxide | Initial |
|---|---|---|
| | concentration | efficiency |
| Experimental group 1 A | 4 wt % | 78% |
| Experimental group 1 B | 5 wt % | 84% |
| Experimental group 1 C | 15 wt % | 95% |
| Experimental group 1 D | 25 wt % | 89% |
| Experimental group 1 E | 26 wt % | 86% |

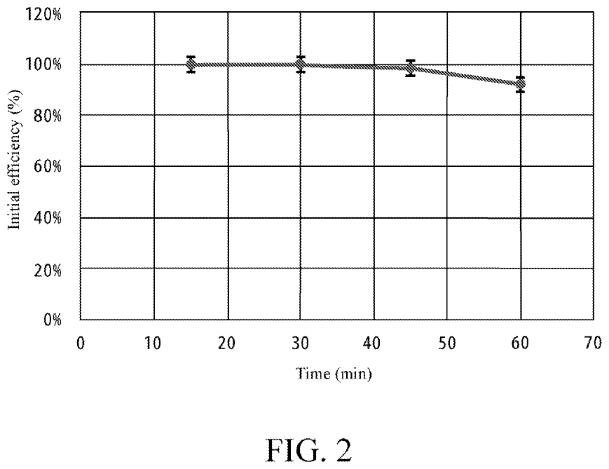

It can be learned that the modified activated carbon prepared by the activated carbon modification method of the present invention has a good effect for removing low-concentration VOCs. The effect of the hydrogen peroxide with a concentration of 15% on modification is the best, with 95% of isopropanol being filtered out. In addition, as shown in FIG. 2, the CV value is 3% after a three-repeat test, indicating that the stability is good.

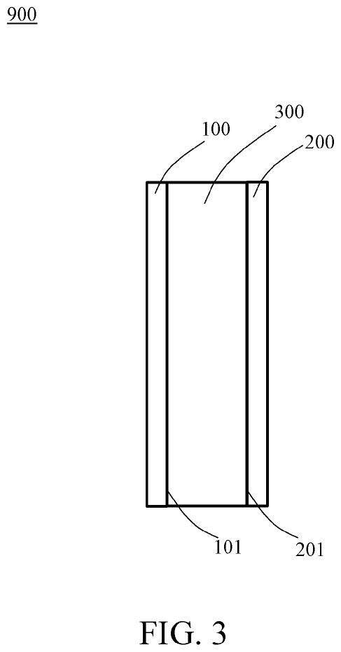

In the embodiment shown in FIG. 3, a filter mesh structure 900 of the present invention includes a first mesh structure 100, a second mesh structure 200, and a filter material 300. The first mesh structure 100 has a first side 101. The second mesh structure 200 has a second side 201, where the second mesh structure 200 is disposed at a side of the first mesh structure 100, so that the second side 201 faces the first side 101. The filter material 300 is provided between the first side 101 and the second side 201, and includes the modified activated carbon prepared by the foregoing activated carbon modification method of the present invention. The filter material 300 can withstand hydrogen peroxide and temperatures above 100° C.

Further, the first mesh structure 100 and the second mesh structure 200 may be selected from alloys such as stainless steel, or other metal or non-metal objects, and may be designed as a mesh or fence, to sandwich the filter material 300 between the first side 101 and the second side 201 and provide the mechanical strength required for support, compression resistance, and impact resistance. For example, nonwoven fabric may be further provided between the filter material 300 and the first side 101, as well as between the filter material 300 and the second side 201, to facilitate fixing the filter material 300 between the first side 101 and the second side 201. In a preferred embodiment, the filter material 300 includes no adhesive, so that it can withstand hydrogen peroxide and temperatures above 100° C. In other different embodiments, the filter material 300 may include an adhesive that can withstand hydrogen peroxide and temperatures above 100° C.

Based on the above, the first mesh structure 100 and the second mesh structure 200 is configured to support the filter material 300 and provide the mechanical strength required for compression resistance and impact resistance, and the filtration effect depends on the filter material 300. The filter material 300 includes the modified activated carbon prepared by the foregoing activated carbon modification method of the present invention, so that the filter mesh structure 900 has a good effect for removing low-concentration VOCs.

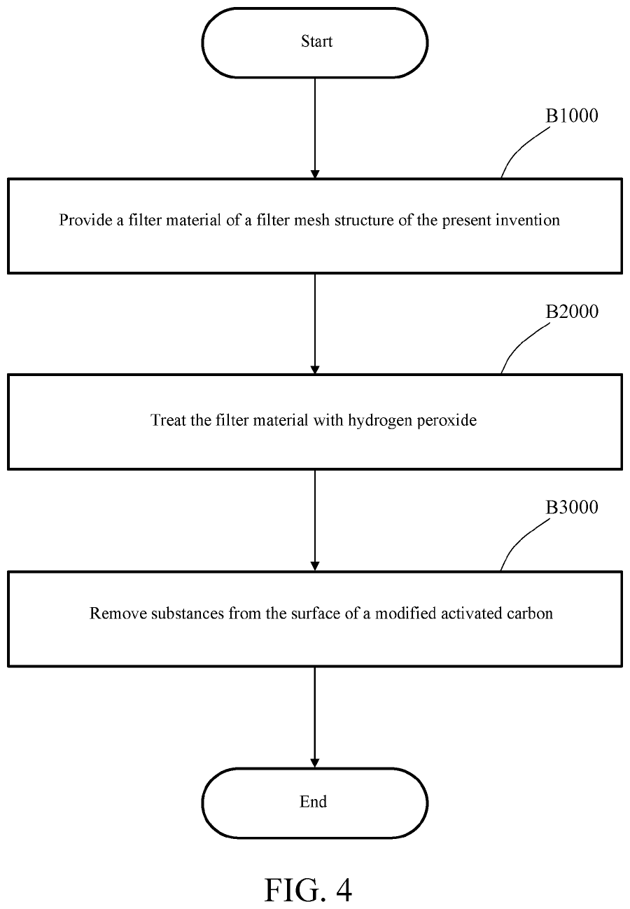

As shown in the schematic flowchart of the embodiment in FIG. 4, in the present invention, a filter material regeneration method includes the following steps.

Step B1000. Provide a filter material of the filter mesh structure as described above.

Step B2000. Treat the filter material with hydrogen peroxide. Specifically, the filter material is soaked in the hydrogen peroxide to remove water-soluble and fat-soluble VOCs through the action of the hydrogen peroxide on the surface of the activated carbon. For the hydrogen peroxide, the concentration is preferably 2-50 wt %, and the pH value is 7±2. However, in other different embodiments, the surface of the activated carbon may be in contact with the hydrogen peroxide to react by repeated dipping or spraying. The concentration of the hydrogen peroxide may be adjusted according to factors such as temperature, way of contact with the surface of the activated carbon, and specifications of the activated carbon. However, in other different embodiments, the surface of the modified activated carbon of the filter material may be in contact with the hydrogen peroxide to react by repeated dipping or spraying. The concentration of the hydrogen peroxide may be adjusted according to factors such as temperature, way of contact with the surface of the modified activated carbon and/or the filter material, and specifications of the activated carbon and/or the filter material. The concentration proportion of hydrogen peroxide in the regeneration process increases with the regeneration frequency.

The advantage of using hydrogen peroxide in the regeneration method is that, in addition to that it is easy to be removed, remains less, and is economical and inexpensive, the waste liquid thereof is easy to handle, and process parameters are easy to control, the same process equipment can be further used because hydrogen peroxide is also used in the process of activated carbon modification in the filter material, that is, hydrogen peroxide is used as an oxidizing agent in the process of modifying activated carbon into modified activated carbon and in the process of regenerating VOC-adsorbed modified activated carbon, so as to reduce equipment investment costs, and avoid outgassing caused from by-products produced after the interaction of different oxidizing agents.

Step B3000. Remove substances from the surface of the modified activated carbon. Specifically, the filter material may be washed with water, and the filter material may be heated to a temperature above 100° C. The method of washing the filter material with water includes soaking the filter material in the water, repeated dipping, or spraying. The filter material is preferably heated to 100° C. to 120° C. However, in other different embodiments, the substances may be removed from the surface of the modified activated carbon by standing, vacuum drying, or the like. From a different perspective, after the filter material is used, VOCs may be adsorbed on the surface of the modified activated carbon, the VOCs may be in contact with hydrogen peroxide to react in the step B2000, and the step B3000 is to remove these VOCs (whether oxidized by hydrogen peroxide or not) and the hydrogen peroxide residue from the surface of the modified activated carbon. In an embodiment, the filter material regeneration method does not include the adjustment of pH or the use of catalysts.

The regeneration effect of the filter material in the filter mesh structure of the present invention is detected as follows.

Specification/Regeneration Method of Filter Material

In the present invention, the regeneration method of the filter material in the filter mesh structure is 2-50 wt % of hydrogen peroxide concentration and 100-120° C. of baking temperature. Specifically, the preparation conditions of experimental groups 2 and 3 are as follows. The concentration of hydrogen peroxide used in the regeneration of experimental group 2 is the same every time. The concentration of hydrogen peroxide used in the regeneration of experimental group 3 gradually increases with the frequency.

Experimental Group 2:

1st-5th regeneration: 1000 mL of 16.5 wt % hydrogen peroxide was prepared with 550 mL of 30 wt % hydrogen peroxide and 450 mL of DI water, and the prepared hydrogen peroxide and 300 g of activated carbon were mixed for 20 min and then dried (at 100° C.), to complete the preparation.

Experimental group 3:

1st regeneration: 1000 mL of 16.5 wt % hydrogen peroxide was prepared with 550 mL of 30 wt % hydrogen peroxide and 450 mL of DI water, and the prepared hydrogen peroxide and 300 g of activated carbon were mixed for 20 min and then dried (at 100° C.), to complete the preparation.

2nd regeneration: 1000 mL of 17.625 wt % hydrogen peroxide was prepared with 587.5 mL of 30 wt % hydrogen peroxide and 412.5 mL of DI water, and the prepared hydrogen peroxide and 300 g of activated carbon were mixed for 20 min and then dried (at 100° C.), to complete the preparation.

3rd regeneration: 1000 mL of 18.75 wt % hydrogen peroxide was prepared with 625 mL of 30 wt % hydrogen peroxide and 375 mL of DI water, and the prepared hydrogen peroxide and 300 g of activated carbon were mixed for 20 min and then dried (at 100° C.), to complete the preparation.

4th regeneration: 1000 mL of 19.875 wt % hydrogen peroxide was prepared with 662.5 mL of 30 wt % hydrogen peroxide and 337.5 mL of DI water, and the prepared hydrogen peroxide and 300 g of activated carbon were mixed for 20 min and then dried (at 100° C.), to complete the preparation.

5th regeneration: 1000 mL of 21 wt % hydrogen peroxide was prepared with 700 mL of 30 wt % hydrogen peroxide and 300 mL of DI water, and the prepared hydrogen peroxide and 300 g of activated carbon were mixed for 20 min and then dried (at 100° C.), to complete the preparation.

Influence of Filter Material Regeneration on Efficiency

The filter material after the regeneration was subjected to the analysis on an effect for removing low-concentration VOCs. The filter material was subjected to the foregoing regeneration steps before a new round of tests for removing low-concentration VOCs. The results are shown in Table 2 below.

TABLE 2

| | Initial efficiency of | Initial efficiency of |
|---|---|---|
| | experimental group 2 | experimental group 3 |
| First use | 93% | 93% |
| 1st regeneration | 86% | 86% |
| 2nd regeneration | 82% | 82% |
| 3rd regeneration | 78% | 92% |
| 4th regeneration | 75% | 87% |
| 5th regeneration | 71% | 89% |

Material Loss of Filter Material after Regeneration

As shown in Table 3 below, the recovery rate of the filter material particles reaches 99% by using the filter material regeneration method of the present invention, which indicates a low material loss.

TABLE 3

| | | Weight (g) | Recovery rate |
|---|---|---|---|
| Before | After screening | 10.216 | 99.01% |
| regeneration | | | |
| After | After screening | 10.115 | |
| regeneration | | | |

Although the above description and figures have revealed the preferred embodiments of the present invention, it is necessary to understand that various additions, many modifications and substitutions can be used in the preferred embodiments of the present invention without departing from the spirit and scope of the principle of the present invention as defined in the claims attached. One of ordinary skill in the art of the present invention should understand that modifications of various forms, structures, arrangements, ratios, materials, elements and components can be made on the present invention. Therefore, the embodiments disclosed herein are used for illustrating the present invention rather than limiting the present invention. The scope of the present invention should be defined by the claims attached, covers legal equivalents thereof and is not limited to the foregoing description.

### SYMBOL DESCRIPTION

100 First mesh structure
101 First side
200 Second mesh structure
201 Second side
300 Filter material
900 Filter mesh structure
A1000 Step
A2000 Step
A3000 Step
B1000 Step
B2000 Step
B3000 Step

### BIOLOGICAL MATERIAL DEPOSIT

(None)

What is claimed is:

1. An activated carbon modification method, comprising:
(A1000) providing an activated carbon;
(A2000) treating the surface of the activated carbon with hydrogen peroxide, so that the activated carbon forms a modified activated carbon; and
(A3000) removing the hydrogen peroxide from the surface of the modified activated carbon.

2. The activated carbon modification method according to claim 1, wherein the step A2000 comprises soaking the activated carbon in the hydrogen peroxide.

3. The activated carbon modification method according to claim 1, wherein the concentration of the hydrogen peroxide is 2-50 wt %.

4. The activated carbon modification method according to claim 1, wherein the step A3000 comprises:
(A3100) washing the modified activated carbon with water; and
(A3200) heating the modified activated carbon to a temperature above 100° C. and below 120° C.

5. The activated carbon modification method according to claim 4, wherein the step A3100 comprises soaking the modified activated carbon in the water.

6. A filter mesh structure, comprising:
a first mesh structure, having a first side;
a second mesh structure, having a second side, wherein the second mesh structure is disposed at a side of the first mesh structure, so that the second side faces the first side; and
a filter material, provided between the first side and the second side, comprising the modified activated carbon prepared by the activated carbon modification method according to claim 1, wherein
the filter material can withstand hydrogen peroxide and temperatures above 100° C.

7. The filter mesh structure according to claim 6, comprising no adhesive.

8. Use of the filter mesh structure according to claim 6 or 7 for removing a volatile organic compound (VOC) contained in an airborne molecular contaminant (AMC).

9. The use according to claim 8, wherein the concentration of the VOC in the AMC is 250 μg/m³ or less.

10. A filter material regeneration method, comprising:
(B1000) providing the filter material of the filter mesh structure according to claim 6;
(B2000) treating the filter material with hydrogen peroxide; and
(B3000) removing substances from the surface of the modified activated carbon.

11. The filter material regeneration method according to claim 10, wherein the step B2000 comprises soaking the filter material in the hydrogen peroxide.

12. The filter material regeneration method according to claim 11, wherein the concentration of the hydrogen peroxide is 2-50 wt %.

13. The filter material regeneration method according to claim 10, wherein the step B3000 comprises:
(B3100) washing the filter material with water; and
(B3200) heating the filter material to a temperature above 100° C. and below 120° C.

14. The filter material regeneration method according to claim 13, wherein the step B3100 comprises soaking the filter material in the water.
